(19) United States
(12) Patent Application Publication
(10) Pub. No.: US 2011/0080746 A1
(43) Pub. Date: Apr. 7, 2011

(54) LIGHTING ENCLOSURE SYSTEM

(76) Inventor: ANTHONY G. PATTI, ALTA LOMA, CA (US)

(21) Appl. No.: 12/899,198

(22) Filed: Oct. 6, 2010

Related U.S. Application Data
(60) Provisional application No. 61/278,574, filed on Oct. 7, 2009.

(51) Int. Cl. F21V 15/01

(52) U.S. Cl. 362/370

(57) ABSTRACT

A lighting enclosure system with a right side extruded metal panel, a left side extruded metal panel, a top cover, a lamp holding panel, a light diffuser panel and a variety of flange members that allow the user to hang the lighting enclosure in a variety of conditions including suspended ceilings, sheet rock ceilings and walls. The right and left side metal brackets including a plurality of horizontally disposed, equally spaced outwardly projecting ribs, each the rib having a plurality of equally spaced, horizontally disposed screw thread retaining ridges that allow the user to attach the flange members in any desired location. Additional side brackets can attach one enclosure system with another in a linear fashion.

### CROSS REFERENCE TO RELATED APPLICATIONS

This application is based on provisional application Ser. No. 61/278,574, filed on Oct. 7, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of lighting enclosures and more specifically to a lighting enclosure system for suspended ceilings that allows for a variety of mounting techniques.

Lighting enclosures, meant to be hidden within the confines of a suspended ceiling and a true ceiling have become commonplace for use in offices, workplaces and some homes. Sometimes lighting enclosures are also hidden behind walls or under floors. Existing lighting enclosures can be time consuming to mount because the conditions of mounting within a given ceiling or wall or floor tend to vary. Therefore, much valuable time is spent on creating custom attachment methods to fasten the lighting enclosure to the existing support structures found in the ceiling, wall or floor.

Additionally, most common lighting enclosures do not have a way to easily attach one enclosure to another in a linear fashion.

### BRIEF SUMMARY OF THE INVENTION

The primary object of the invention is to provide a lighting enclosure system that can accommodate a wide variety on installation conditions thereby avoiding time consuming and expensive custom fabrication of support members.

Another object of the invention is to provide a lighting enclosure system that allows the user to attach the lighting enclosure to standard T bar ceiling brackets.

Another object of the invention is to provide a lighting enclosure system that allows the user to attach the lighting enclosure to sheet rock.

A further object of the invention is to provide a lighting enclosure system that allows the user to attach the lighting enclosure to walls.

Yet another object of the invention is to provide a lighting enclosure system that allows the user to attach the lighting enclosure to hanging threaded posts.

Still yet another object of the invention is to provide a lighting enclosure system that allows the user to attach one lighting enclosure to another in an end to end fashion.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a lighting enclosure system comprising: a right side extruded metal panel, a left side extruded metal panel, a top cover, a lamp holding panel, a light diffuser panel, a left and right backer flange, a left and right plaster flange, a front and rear plaster flange, a right and left wall hanger bracket, a front and rear end enclosure plate, a left and right hanger bracket, a plurality of post holder brackets, a left and right spine bracket, a left and right trim flange said right and left side metal brackets including a plurality of horizontally disposed, equally spaced outwardly projecting ribs, each said rib having a plurality of equally spaced, horizontally disposed screw thread retaining ridges, said top cover fixedly attached to the top edge of said left and right side panels, said plaster flanges capable of fastening to the bottom edge of said left and right extruded panels, said light diffuser panel attached to the inside walls of said plaster flanges, said lamp holding panel attached at a mid-point between said left and right extruded panels, said left and right hanger bracket capable of being attached to the outside surface of said of said left and right extruded panels, said rear enclosure plate mounted at the rear end of said left and right panels, said post holder brackets capable of being mounted on the upper portion of said side panels or said end enclosure plates, and said spine brackets capable of being mounted on the outside surface of said left and right extruded panels in such a way as to allow connection of one lighting enclosure assembly to another in a linear fashion, said trim flanges capable of being mounted at the bottom edges of said left and right metal panels in an outward orientation and said trim flanges capable of removal yet retaining said light diffuser panel.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a end view of the invention showing trim mounting flanges.

FIG. 3 is a partial end view of the trim flange portion of the invention.

FIG. 4 is a partial view of the screw retaining ribs of the invention.

FIG. 5 is an end view of the invention showing T bar mounting flanges.

FIG. 6 is a partial end view showing the attachment means for the trim flanges.

FIG. 7 is a perspective view of the spring biased compression bracket for holding the trim flanges to the side panels.

FIG. 8 is a perspective view of an auxiliary bracket to retain standard post hangers.

FIG. 9 is a perspective view of a completed enclosure system.

FIG. 10 is a perspective end view of the enclosure system with the rear wall removed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

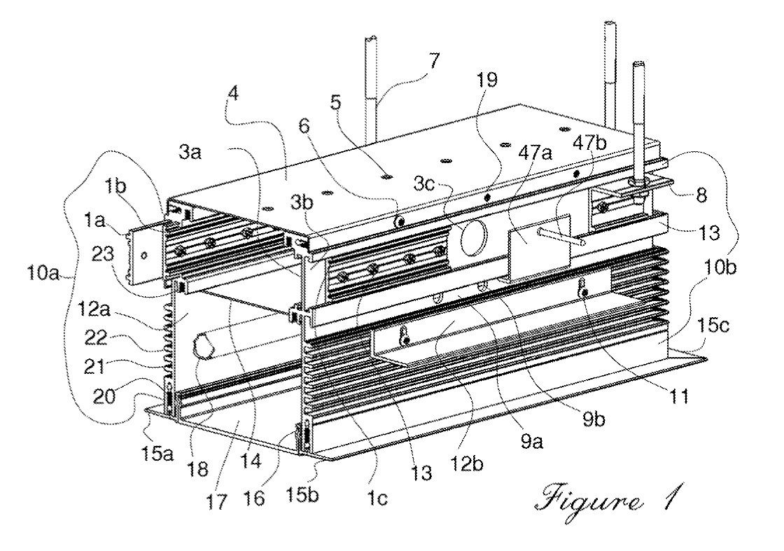

FIGS. 1 and 2 illustrate the first main or commercial embodiment of the present invention initially consisting of, but is not limited to, an enclosure or housing, that consists of a built-up assembly of multiple components designed with many functionally novel and mechanically unique properties: Uniquely extruded left and right side wall panels 10a and 10b, when used in a combinations with other such panels cut in matching or opposing lengths, allow for the initial foundations of robustly constructed enclosures or housings that may be used in the multiple size or shape variations required in various modular fixtures or system enclosure applications; particularly lighting enclosures. The foundational side panels 10a, 10b have many original features and functionalities heretofore not incorporated into any prior art enclosure panels as now detailed.

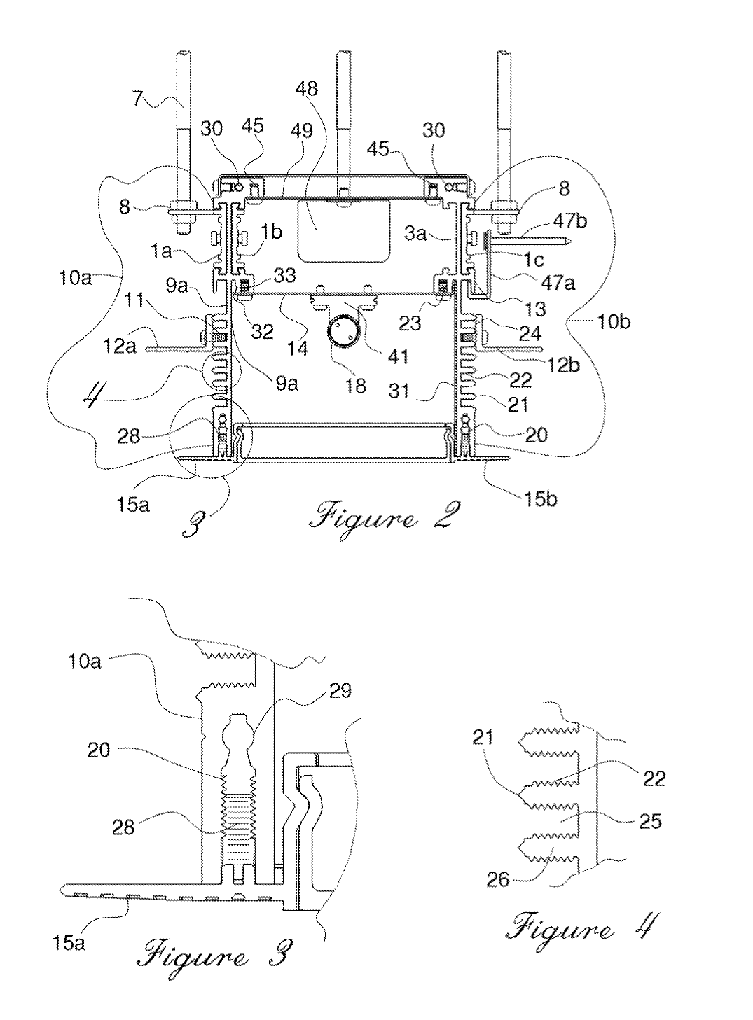

As shown in FIG. 3 and FIG. 4; in order to allow for the resultant enclosure to accurately adjust or match in parallel to the plane of any ceiling, wall, floor or mounting platform surface, and to adjust to the multiple thickness variations of ceiling, wall, floor or mounting platform possibilities, the vertical side panels 10a, 10b have evenly spaced and precisely ridged 25 horizontal ribs 26 on the lower outer surface of its main side walls 10a, 10b that are intended to work in conjunction with separate yet mechanically matching backer flanges 12a, 12b that allow the above mentioned adjustments to ceiling, wall, floor or mounting platform materials.

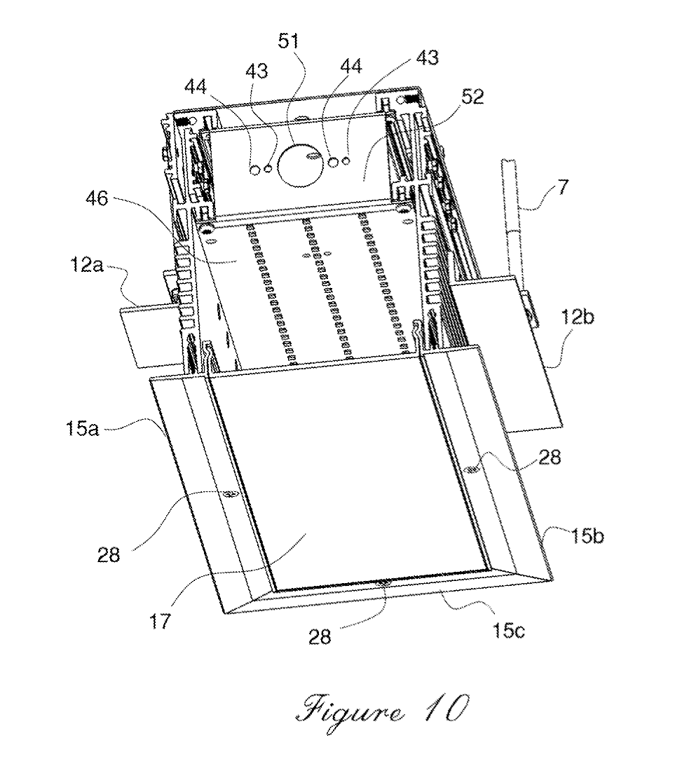

FIG. 2; to allow for these accurate vertical pre-adjustments, the separate backer flanges 12a, 12b are precision matched to the horizontal side panel ribs 26 with close fitting slotted rib spaces 24, so they can incrementally adjust to each other, in precise 1/16 inch increments. In addition, to allow for a locking process with the pre-adjusted mating backer flanges using #8-32, or other, set screws passing through pre-drilled holes in the vertical flange walls, each horizontal side panel rib 26 is spaced from each other rib 26 with internal #8-32 UNC, or other, threads 22 designed to catch the #8-32, or other, screw shanks 11. This design allows the lower backer flange surface to closely mate to, or back up, the back side of the intended ceiling, wall, floor or mounting platform thickness. These adjustment options start at, but not limited to, a nominal thickness range of ½ inch and allow for a final thickness adjustment limit of 2¼ inch, but not limited to, in the given increments, giving the fundamental enclosure an almost complete range of flush-to-surface mounting options for the majority of ceiling, wall, floor or mounting platform thickness found in the world. After the required thickness adjustment is found, plaster flanges 15a, 15b, 15c, shown in FIGS. 1 and 10, are locked into position by multiple logically spaced #8-32, or other, screws 11 and are then ready for ceiling, wall, floor or mounting platform installation. A fourth plaster flange 15d is not shown, however it is the same shape and size as flange 15c and completes the rectilinear frame.

Unlike other somewhat similar enclosure products on the market, to fine tune or correct for any unforeseen ceiling, wall, floor or mounting platform thickness variations, the backer flanges 12a, 12b, may be post adjusted and then re-locked at any time in the future in both the vertical, or up-down, direction or in the lateral, or horizontal, direction to accurately compensate for these thickness variations. Very importantly, the backer flanges 12a, 12b provide a function that literally eliminates the previous requirement for all back up framing material, labors or mechanical/hardware requirements. Therein, the backer flanges 12a, 12b replace the requirement for conventional backer “framing” allowing the chosen ceiling, wall, floor or mounting platform material(S) to be directly attached to these flanges 12a, 12b by conventional screwing methods such as those presently used on gypsum drywall. This feature alone enables the enclosure to be installed in almost any desired location and is therefore not limited by any existing or proposed ceiling joist positions or typical framing confinements. Prior to installation, to compensate for any known or unknown obstructions that may need to be avoided during actual enclosure installations in the field, the flanges 12a, 12b, may be easily loosened and then, either laterally or horizontally readjusted or slid, mechanically shortened or cut or trimmed to fit. The flanges 12a, 12b, may also be factory or field removed to allow for a direct-to-soffit, or slide- in installation, whereas the platform openings or surface materials or existing ceiling, wall, floor or mounting are already framed-in or fully finished and in place with zero side wall clearance. This is an immensely valuable option that is not presently found in other enclosure offerings with fixed flange assemblies.

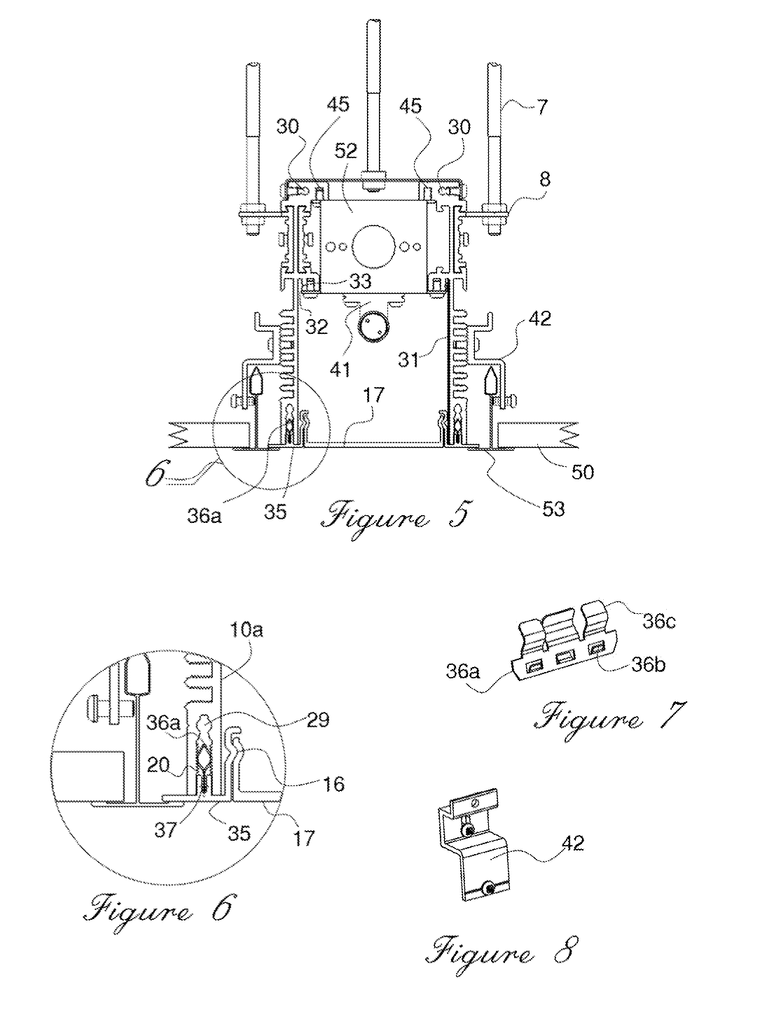

FIG. 1 and FIG. 5; the second main or commercial embodiment of the present invention initially consists of, but is not limited to, additional features of the above mentioned extruded side wall panel 10a, 10b, 10c, in conjunction with the uniquely designed auxiliary bracket 42 for attaching standard T-Bar flanges 53, hereafter called T bar locking flange, found in many suspended ceilings The novel design of the extruded T-Bar locking flange 42, when used with almost any variety of commercially available acoustic T-Bar 53 channel systems or other panel 50 materials, allows for the almost complete linear and vertical positional adjustability of the fixture enclosure and the associated trim aesthetics. The incrementally threaded sidewalls of the main side wall extrusion 10a, 10b, 10c, allow the extruded T-Bar locking flange 42 to either move up or down in 1/16 inch increments to precisely allow for, or adjust to the varying thickness of acoustic panels 50, acoustic panel with T-bar thickness variations, or other accessory panel material variations or accessories with panel combinations. The T-Bar locking flanges 42 is also infinitely adjustable in the horizontal direction to effectively accommodate or allow for any fixture load bearing concerns or to compensate for unexpected installation obstructions.

FIG. 1 and FIGS. 2 and 10: the third main or commercial embodiment of the present invention initially consists of, but is not limited to, additional features of the above mentioned extruded side wall panels 10a, 10b, 10c. A partially threaded vertical slot 20, with #8-32 UNC, or other, horizontal threads, is built into the precise centerline of the panel base with unique capabilities. The threaded slot 20 either directly performs, or allows for, three separately valuable and unique functions as follows: FIG. 2 and FIG. 3; first threaded slot function, to directly, or vertically, receive and accept one or more #8-32 UNC, or other, screws 28 at any linear position along its entire lower horizontal length, to mechanically mount a precisely designed and matched, extruded or other, mud-in, plaster-in, or trim-less flange 15a, 15b, 15c, etc., to this said side panel lower edge. A very unique and valuable aspect of this thread concept allows for the optional pre-installation of this flange in the factory prior to the enclosure shipping or later on, just before the installation process in the field. Then again, this design allows for easy post loosening, adjustment or removal of this flange 15a, 15b, 15c, etc, either in the factory or in the field for adjustments or various unforeseen reasons.

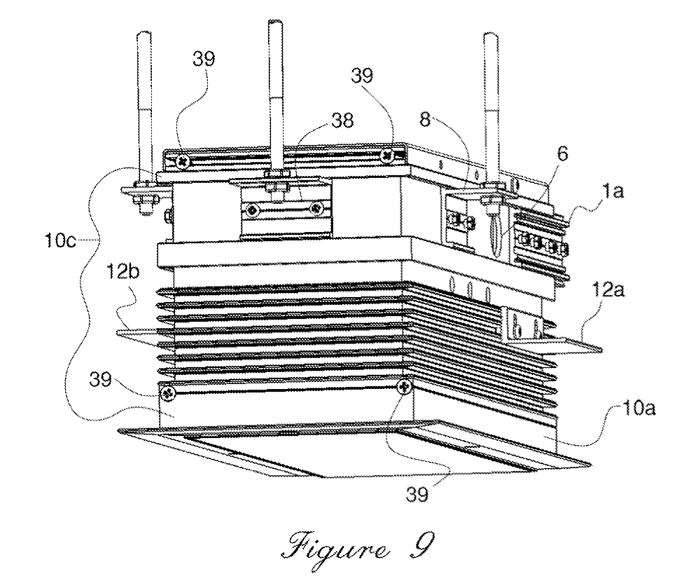

FIG. 5, FIG. 6 and FIG. 7; second threaded slot function: the threaded slot 20 is also specially designed to receive and firmly hold onto a unique spring clip 36a that is permanently installed onto multiple logically spaced locations, via locking teeth 36b, within the extruded receiver slots 37 of the linear lengths of aesthetic trim flanges 35, so said trim 35 is thereby removable for interior enclosure access or accessory holding capabilities. Depending on the design intent and fixture usage, these removable trim types have many profile and functionality variations. Most types of these removable trims are based on aesthetic designs and may vary as a unique look or special trim function is desired. The spring clip and its additional features and functions will be described more fully later on in this disclosure.

FIGS. 3 and FIG. 9; third threaded slot function: the top of the threaded vertical slot in the extrusion also contains an extruded semi-round hole profile 29. This extruded hole profile 29, in combination with another similar extruded hole profile 30 located at the uppermost top edge of the extrusion, are both extruded to the standard extrusion diameter necessary for tightly receiving self-tapping #8-32 UNC, or other thread pitch screws, and to effectively miter cut mount end panel pieces 10c, with other miter cut panel pieces, and appropriately bored screw holes that correspond to specific enclosure angles or shapes as further explained below. In the case of creating rectangular or square enclosures, all end panel pieces are cut from the same extruded side panel material 10a, 10b, 10c. They are the same standard 45 degree miters as those used to create most standard commercial picture frame corners. In addition, to create a precisely rectangular enclosure, the two end panels 10c and 10d, not shown but the same as 10c, would be shorter than the two longer side panels 10a, 10b making up the rectangle. Logically, to create a precisely square enclosure, the two end panel 10c, 10d lengths would be the same length as the side panels 10a, 10b. In either case, four extruded panels in total would be required to complete most rectangular or square or four sided enclosures and to rigidly finish off an enclosure assembly. If needed, other enclosure shapes, such a hexagonal, or six sided, or octagonal, or eight sided, can be easily constructed by choosing and cutting other matching miter cut angles, and the appropriately bored screw holes, to produce such enclosure shapes. Other more complex shapes can be produced by using the same miter cutting rules and principles. Also, by mounting multiple shorter enclosures together end-to-end, as soon to be discussed below in the next commercial embodiment of this invention, a process is contained within this invention to easily produce longer, or continuous length, enclosures or enclosures with special combinations of single, or multiple, acute, obtuse or right angle turns.

FIG. 1 and FIG. 2; the forth main or commercial embodiment of the present invention relates to: the novel and technically advanced mechanical features of effectively and confidently joining multiple quantities or shapes of the aforementioned enclosures together end-to-end to precisely create a continuous or uninterrupted enclosure or channel, in any of the above mentioned variations, with little effort or mechanical complexities. The above mentioned extruded side wall panel 10a, 10b, 10c, 10d, has another integrally designed feature that works in conjunction with another specially designed component. Symmetrically located on both the upper interior and the upper exterior side walls of the extruded side wall panel 10a, 10b are specially designed enclosed channels 3a and 3b, each channel containing an opposing female dovetail of a unique design on each of their interior corners, one upper corner and one lower corner, which are designed to perform, in tandem, a mechanically novel function. In practice, for the simple logic of mechanical performance, installation expedience or for future interior access requirements, either the interior or the exterior channel positions are selected for use during a specific enclosure installation for the aforementioned reasons. To explain; as the enclosed end of a semi-completed enclosure, shown in FIG. 10, comes in contact with the unclosed end of another semi-completed enclosure, a method of bridging the two together is accomplished via the dual alignment of both female dovetailed channels 3a or 3b and the introduction of, and sliding together of, a matching set of male dovetailed splines 1a, 1b, 1c. After the male dovetailed splines 1a, 1b, 1c, are engaged and manually centered between the two enclosures, which are now in a firm end-to-end contact, the male and female dovetail profiles, as contained within the now mating channels and the integral splines, are now robustly locked together by the simple compression tightening of their associated set screws 13. This unique tightening and locking action creates a precision clamping effect of the two mating dovetail profiles, which are now in compressive contact, bringing together a one-of-a-kind physical locking action with an absolutely precise and perfectly matched fit between enclosures. Also, by the fact that no pre-drilling or pre-matching of typical drilled spline brackets are required and the tolerance issues of bolt-and-plate assemblies or welded spline mounting methods are not present here, an infinitely more reliable joinery of enclosures is automatically provided and consistently repeatable. Also, because it can be loosened anytime, then readjusted and re-tightened, the connection is as permanent or as semi-permanent as ever needed. A further valuable feature of the movable, or sliding, spline 1a, 1b, 1c, etc., design allows the splines to be fully recessed and semi-locked temporarily into the enclosure interior, or exterior, until a spline-to-channel engagement is required during installation. Also, this 1a, 1b, 1c, etc., temporarily recessed spline feature is incredibly valuable because it will save on shipping container sizes; eliminate handling safety issues as there are no protruding knife-like splines or brackets; eliminate installation errors resulting from the mismatching of previously drilled, welded or factory set fixture splines, or brackets; and allow for an absolutely vertical and a directly edge-to-edge installation and locking of two, or more, adjoining or mating fixture enclosures into a pre-defined or pre-framed ceiling, wall, floor or mounting platform space, even into an insertion space with zero side shift allowance. Other related qualities or functions of the above mentioned invention components will be discussed in the following when applicable.

FIG. 1 and FIG. 2; the fifth main or commercial embodiment of the present invention again consists of, but is not limited to, additional novel features of the above mentioned extruded side wall panel acting directly with the corresponding novel features of another mating component invention, namely: the hanger bracket 8. Hanger bracket 8 is designed to retain the end of a standard post hanger 7. Unlike other previous art methods or fixed means of hanging or installing fixture enclosures during the rough-in stage of enclosure installation, this hanger bracket 8 invention, sliding within the previously mentioned exterior form of the opposing female dovetail channels integrated within the side panel 10a, 10b walls, has the unique ability to be manually adjusted into any linear position that best compensates for the most optimal hanger positioning or to clear any unforeseen physical objects that may obstruct or hinder an optimal enclosure installation. The hanger brackets are designed to accept most standard #¼-20, or other, threaded down rod 7 and lock nuts, or other wire, cable, strap, screw-to-stud or other make-shift hanging hardware. Also, by virtue of the simple unlock/lock capability of the integral #8-32, or other, locking screws on the brackets, this optimal positioning may be determined before, during or after the initial ceiling, wall, floor or mounting platform installation and may also be re-adjusted, or fine tuned, at any time in the future for any unforeseen reasons. Also, because of the universal use of the generic extruded side panel material on all of the resultant vertical surfaces of the proposed enclosure design, the hanger bracket 8, or brackets, may be used with the same freedom of adjustability on any, or all, of the resultant side panels or, as in the case of rectangular or elongated enclosures. If for any reason prior to enclosure installation, it is found that the brackets 8 are not needed, or they are themselves are found to be an obstruction during installation, they may be completely removed from the enclosure side wall, or walls, by simply loosening their integral lock screws and sliding the bracket, or brackets, off the open end of a channel wall. This is very valuable in the sense that enclosures may now be made as stock or generic assemblies and simply, yet precisely, modified to fit the known or unknown installation requirements, or limitations, either in the manufacturing facility before shipping or after-the-fact in the field.

FIG. 1; the sixth main or commercial embodiment of the present invention again consists of, but is not limited to, additional novel features of the above mentioned extruded side wall panels 10a, 10b, in this case: an extruded #8-32 slot 30 or other thread pitch, located on the slightly recessed, uppermost top exterior edge of this said 10a, 10b, 10c, 10d, panel. This functional intent of this particular threaded slot is twofold. First intent: to hold the formed ninety degree perimeter flanges of corresponding enclosure covers 4, predominantly made from sheet metal, with logically spaced perimeter flange perforations 19 to allow for the necessary #8-32, or other, machine screws to pass through to the linear threads. This screw 6 and cover 4 assembly essentially forms and functionally holds together the two, or more, sides of the foundational enclosure box until other enclosure components or interior accessories, such as end plates, interior cover plates or additional side panels, are installed. Second intent of threaded linear slot: the threaded linear slot also provides a very broad, linear mounting zone for the selectable positioning of, or repositioning of, perforated strap material, perforated tabs, or other fixture hanging hardware on the exterior surface of and through the unused flange perforations 19 of the aforementioned cover 4 with additional screws or under the initial cover hold down screws. The cover 4 has the added feature of a logically spaced set of linear perforations 5 located on the top most center line of the cover surface. These perforations 5 allow the enclosure to be firmly and precisely installed, or hung, in the recess of a zero side shift ceiling, wall, floor or mounting platform using standard threaded down rod and lock nuts or other centerline hanging procedures.

FIG. 1 and FIG. 2; the seventh main or commercial embodiment of the present invention again consist of, but are not limited to, additional novel features of the above mentioned extruded side wall panel, in this case: located on the midline vertical interior side wall of the side panel, is a continuously extruded, horizontal linear boss 23 with a continuous vertically extruded #8-32 UNC, or other thread pitch, threaded accessory mounting slot. This threaded linear boss 23, when used in symmetrical plurality with another side wall panel of the same, or in opposing combinations of multiple side wall panels 10a, 10b, 10c, etc. of the same profile, is designed to directly receive matching retainer screws. Such screws will hold onto appropriately perforated and sized accessory plates 14 or interior cover panels 14 such as fluorescent 18 lighting socket plates, or brackets with sockets 41, or ballast wiring access panels, baffles or reflector strips, gimbal lamp mounts, L.E.D. or other technology PC boards 46, structural cross plates, etc. Such screw attached items, panels or accessories, by virtue of the smooth and obstruction free side walls just below this continuous linear boss, are easily removed, adjusted, added to or replaced.

FIG. 2 and FIG. 5; the eighth main or commercial embodiment of the present invention again consist of, but are not limited to, very unique pre-finished interior panel inserts 31, which are inserted into any of the receiving slots 32, such slots being formed by the outermost wall of the aforementioned threaded boss 23 and the interior wall of side panel 10a, 10b, 10c. The inserts are held in place via multiple punched and formed dimples 33, that compressively fall into a mating groove within this receiving slot 32. This interior panel feature is immensely valuable in the sense that it eliminates the need to separately paint the entire surfaces of side panel components 10a, 10b, 10c, or the entire fixture interior. In valuable addition, these panels may be replaced or updated as desired in the future to provide additional interior color schemes, light reflector options or other fixture functionalities or options.

FIG. 1 and FIG. 5; the ninth main or commercial embodiment of the present invention again consist of, but are not limited to, additional novel features of the above mentioned extruded side wall panel, in this case: located on the upper most vertical side wall of the side panel 10a, 10b interior, is another continuously extruded, horizontal linear boss 45 with a continuous vertically extruded #8-32 UNC, or other thread pitch, threaded accessory mounting slot. This threaded linear boss 45, when used in symmetrical plurality with another side wall panel of the same, or in opposing combinations of multiple side wall panels 10a, 10b, 10c, etc. of the same profile, is designed to directly receive matching retainer screws. Such screws will hold onto appropriately perforated and sized accessory, ballast 48, or power supply mounting plates 49 or other interior panels 49 such as new technology lighting ballasts and wiring access panels. Such screw attached items, panels or accessories, by virtue of the smooth and obstruction free interior side wall located just below the linear boss location, are easily installed, removed, adjusted, added to or replaced and/or conveniently allow for in-the-field installation of complete wiring modules after the preliminary or rough installation of empty or partially assembled enclosure housings.

FIG. 1; the tenth main or commercial embodiment of the present invention again consists of, but is not limited to, an additional novel feature of the above mentioned extruded side wall panel, in this case: noting the recessed vertical flat wall space within the flat zone of the aforementioned enclosed side panel channels 10a, 10b with opposing female dovetails, the design and width of this wall space 3a interior side, or 3b exterior side, was specifically calculated and located to allow for the most unrestricted positional selection and installation of any required conduit connector or connectors in any desired side or end mount location, of which the hole size 3c and locations of may be appropriately selected prior to enclosure shipment or post installed “in the field”. These flat spaces may also be used for pre-engineered heat venting perforations, as required or allowed for in high thermal transfer applications.

FIG. 1; the eleventh main or commercial embodiment of the present invention again consists of, but is not limited to, an additional novel feature of the above mentioned extruded side wall panel, in this case: noting the smaller horizontally linear vertical flat space 9a, located just below the above mentioned flat wall space 3a, 3b, the design and width of this space was specifically positioned to accommodate the potentially required addition of heat venting perforations 9b and to therein, effectively allow for the most efficient dissipation of the excessive heat or thermal radiation qualities of certain high temperature lamps or accessories.

FIG. 5 and FIG. 10; the twelfth main or commercial embodiment of the present invention again consists of, but is not limited to, a novel structural plate 52 that has at least two unique functions. First: such a plate 52, used in any desired median position along the entire linear length of such an enclosure, acts a fixture strengthening plate for the added integrity of the fixture enclosure or as an accessory divider or shield plate for the component separation or zoning within the fixture enclosure. Second: used in an end-of-enclosure position, the plate 52 not only becomes a means to reinforce or stabilize the enclosure ends but performs the added function of an enclosure-to-enclosure joiner plate. Two such enclosures, when brought together end to end, are effectively attached together by using two #8-32, or other thread pitch, set screws that match a quasi-symmetrical matched set of two pre-punched thru 44 and two threaded holes 43 in the each plate. A large diameter center matched hole 51 allows for data line or thru-wiring passage. This plate works in tandem with the aforementioned male dovetailed splines 1a, 1b, 1c, etc., within the extrusion side walls, helping to further align and stabilize the enclosure-to-enclosure lock process.

FIG. 6; the thirteenth main or commercial embodiment of the present invention again consists of, but is not limited to, is a unique extrusion based lens or accessory holding flange system for use with lighting trims, air control louvers or diffusers or other system trims or aesthetics: First: using novel enclosure flange extrusions with universal profiles 16, a multiplicity of snap-in or lay-in lenses 17, reflectors, louvers or air control diffuser designs with varying functions or appearances may be installed, interchanged, upgraded or combined within the same enclosure housing with little difficulty or technical complexity. Second: a complete variety of aesthetic trim styles, such as depicted in part 35, may also be pre-selected or post-selected, replaced, changed out or upgraded at any time in the future. Thirdly: to conveniently match present, future or modified color schemes without the worry of mechanically damaging attached hardware or paint fogging of related aesthetic enclosure, lens or trim extrusion surfaces, all trims may be temporarily removed and externally or remotely painted or refinished by virtue of the permanently attached snap-in clip 36a that allows for such functional versatility.

FIG. 1 and FIG. 2; the fourteenth main or commercial embodiment of the present invention again consists of, but is not limited to, the unique fixture-to-wall horizontal hanging rail 13 co-extruded onto the upper section of the side wall panels 10a and 10b in combination use with the mating, either formed or extruded, wall hanger bracket 14a and any required attachment hardware 14b such as nails, screws or bolts. Noting that the wall hanger bracket 14a, by virtue of its easy mobility and regardless of its final size, may be horizontally wall or surface mounted to almost any predetermined position which is convenient or assures a safe attachment to wall or wall studs. Depending on the hanger bracket 14a, fixture length or logical cost economy, attaching or hanging the completed mechanical fixture requires either a single elongated hanger bracket 14a or a group of two or more 14a hanger brackets of acceptable length. The final fixture hanging process is completed via a lift and drop hooking action onto the extruded hanger rail 13 on either the 10a or the 10b side panel. After hanging, the fixture position may be easily adjusted horizontal by sliding, vertically adjusted by repositioning and remounting the bracket 14a locations.

It should also be understood that, in addition to an extrusion and sheet metal based recessed or semi-recessed linear channel lighting or mechanical enclosure system, the system can also be used for retail or commercial sales banner enclosures and other new or developing technology enclosures as those technologies or system types become available.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. lighting enclosure system comprising:
a right side extruded metal panel;
a left side extruded metal panel;
a top cover;
a lamp holding panel;
a light diffuser panel;
a left and right backer flange;
a left and right plaster flange;
a front and rear plaster flange;
a right and left wall hanger bracket;
a front and rear end enclosure plate;
a left and right hanger bracket;
a plurality of post holder brackets;
a left and right spline bracket;
a left and right trim flange
said right and left side metal brackets including a plurality of horizontally disposed, equally spaced outwardly projecting ribs;
each said rib having a plurality of equally spaced, horizontally disposed screw thread retaining ridges;
said top cover fixedly attached to the top edge of said left and right side panels;
said plaster flanges capable of fastening to the bottom edge of said left and right extruded panels;
said light diffuser panel attached to the inside walls of said plaster flanges;
said lamp holding panel attached at a mid-point between said left and right extruded panels;
said left and right hanger bracket capable of being attached to the outside surface of said of said left and right extruded panels;
said rear enclosure plate mounted at the rear end of said left and right panels;
said post holder brackets capable of being mounted on the upper portion of said side panels or said end enclosure plates; and
said spline brackets capable of being mounted on the outside surface of said left and right extruded panels in such a way as to allow the connection of one lighting enclosure assembly to another in a linear fashion
said trim flanges capable of being mounted at the bottom edges of said left and right metal panels in an outward orientation and said trim flanges capable of removal yet retaining said light diffuser panel;

2. A lighting enclosure system as claimed in claim 1 wherein said left and right panels include a plurality of ventilation apertures.

3. A lighting enclosure system as claimed in claim 1 wherein said right and left panels include knockout apertures for electrical wiring.

4. A lighting enclosure system as claimed in claim 1 wherein auxiliary brackets can be attached to the outside walls of said left and right panels so that standard T bar ceiling supports can be attached to said auxiliary brackets.

5. A lighting enclosure system as claimed in claim 1 further comprising a compression bracket attaches to said trim flanges to the underside edge of said right and left metal panels.
